(19) United States
(12) Patent Application Publication
(10) Pub. No.: US 2006/0072964 A1
(43) Pub. Date: Apr. 6, 2006

(54) Stepless rotational joint

(76) Inventor: Jui-Pin Chen, Banciao City (TW)

Correspondence Address: Yi-Wen Tseng, 4331 Stevens Battle Lane, Fairfax, VA, 22033, US

(21) Appl. No.: 10/957,596

(22) Filed: Oct. 5, 2004

(51) Int. Cl. F16D 1/12

(52) U.S. Cl. 403/105

(57) ABSTRACT

A stepless rotational joint that is able to attain a more precise and smooth operation than a conventional art does. The stepless rotational joint includes a shell body, a lower mount, a driving element with two driving planes, a rotational disk, an upper mount, and a switch device. When a torque is applied along a selected rotational direction, the rotational disk will be driven to rotate along the selected direction because the top and the bottom end surfaces of the rotational disk are respectively engaged with an oblique plane of the upper mount and one of the driving plane of the driving element. The rotation of the rotational disk will further drive the lower mount to rotate synchronously along the selected direction.

### BACKGROUND OF THE INVENTION

The present invention relates in general to a rotational joint, and more particularly, to a stepless rotational joint.

The rotational joint is popularly utilized within products that have either a single or bi-directional rotating mechanism, such as a ratchet wrench, a desk lamp adjusting lever, or an orienting axle connecting a chair back to a chair seat. The conventional art utilizes a ratchet and pawl mechanism, or a concave and convex element, or a spring and steel ball combination to complete a single or bi-directional rotation and orientation. But, those mechanisms are unable to acquire a precise orientation because of their structures' limitations.

Further, there was a stepless rotational joint disclosed in a Taiwan utility patent, publishing number 122187. The patent disclosed a stepless ratchet wrench structure which comprises a slot opening formed in the main body, and an engaging element with an axial tooth portion which is installed together with a spring element inside the slot opening. In one rotational direction the axial tooth portion of the engaging element is engaged with the teeth of a pawl block while the other rotational direction is not engaged because this rotational direction is in the same direction as the direction of the force of the spring element. Thus, the stepless ratchet wrench is able to perform its function. This stepless ratchet wrench can attain a more precise rotational operation than other conventional ratchet wrenches. However, this stepless ratchet wrench is still unable to achieve a truly stepless operation because of the limitation imposed by their tooth structure.

### BRIEF SUMMARY OF THE INVENTION

The present invention provides a stepless rotational joint that is able to perform a stepless single directional or bi-directional rotation. The present invention thereby attains a more precise and smooth operation than a conventional art does.

The stepless rotational joint of the present invention includes a shell body, a lower mount, a driving element with two driving planes, a rotational disk, an upper mount, and a switch device. In a rotational operation, one driving plane of the driving element will be engaged with the rotational disk and the upper mount. The switch device is utilized to select the driving plane to be engaged. Further, because the rotational disk is assembled with the lower mount, the rotation of the rotational disk will drive the lower mount to rotate. When a consumer applies a torque along a selected rotational direction, the rotational disk will be driven to rotate along the selected direction because the top and the bottom end surfaces of the rotational disk are respectively engaged with an oblique plane of the upper mount and one of the driving plane. The rotation of the rotational disk will further drive the lower mount to rotate synchronously along the selected direction. When a torque opposite to the selected rotational direction is applied, the rotational disk will be pushed downward and against a transition area of the driving element. The upper mount is thereby oriented because the transition area, the rotational disk, and the upper mount are interlocked together. The present invention is thereby able to prevent reverse slippage. Furthermore, the present invention utilizes the driving plane to engage with the rotational disk and the upper mount. In other word, the present invention is stepless so that it is more precise than conventional arts are.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a perspective view of one embodiment of the present invention.

FIG. 2 is an exploded view of one embodiment of the present invention.

FIG. 3 is a cross-sectional view of one embodiment of the present invention.

FIG. 4 is a schematic diagram illustrating a condition that the first rotational direction of the stepless rotational joint is selected.

FIG. 5 is a partial cross-sectional view illustrating the driving rotation along the first rotational direction.

FIG. 6 is a partial cross-sectional view illustrating the orienting status under the first rotational direction.

FIG. 7 is a schematic diagram illustrating a condition that the second rotational direction of the stepless rotational joint is selected.

FIG. 8 is a partial cross-sectional view illustrating the driving rotation along the second rotational direction.

FIG. 9 is a partial cross-sectional view illustrating the orienting status under the second rotational direction.

FIG. 10 is perspective view of a bi-directional wrench utilizing the present invention.

FIG. 11 is perspective view of a lamp brace junction utilizing the present invention.

FIG. 12 is perspective view of a chair frame utilizing the present invention.

FIG. 13 is an enlarged view of the chair frame junction of FIG. 12.

FIG. 14 is an exploded view of another embodiment of the present invention.

FIG. 15 is a partial cross-sectional view illustrating the driving rotation along the single rotational direction.

FIG. 16 is perspective view of a single directional wrench utilizing the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

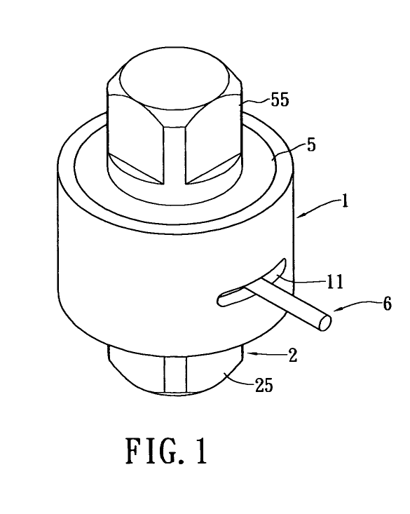

Referring to FIG. 1 through FIG. 3, a stepless rotational joint of the present invention capable of bi-directional operation is illustrated. The stepless rotational joint of the present invention includes a shell body 1, a lower mount 2, a driving element 3, a rotational disk 4, an upper mount 5, and a switch device 6. The shell body 1 is shaped into a hollow cylinder which has a slot opening 11 formed at one side thereof. The slot opening 11 provides an operational space which the switch device 6 utilizes in switching the rotational direction.

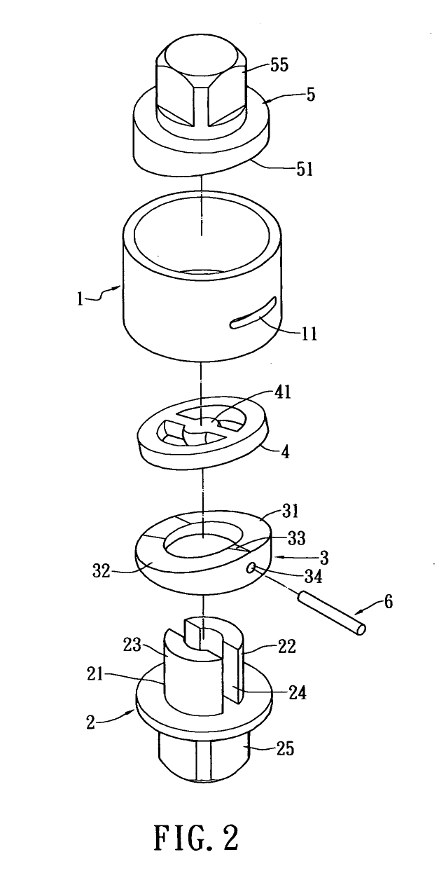

The lower mount 2 is installed inside the shell body 1, as shown in FIG. 2. The lower mount 2, which shares the same axis as the shell body 1, includes an assemble shaft 21 which extends, from one end thereof, toward the shell body 1; and a connecting head 25 which protrudes from the opposite side. The assemble shaft 21 is constituted by two semi cylindrical plates 22, 23 separated by a assemble slot 24. The connecting head 25 is able to connect to a product or a tool utilizing the present invention, for example, a socket.

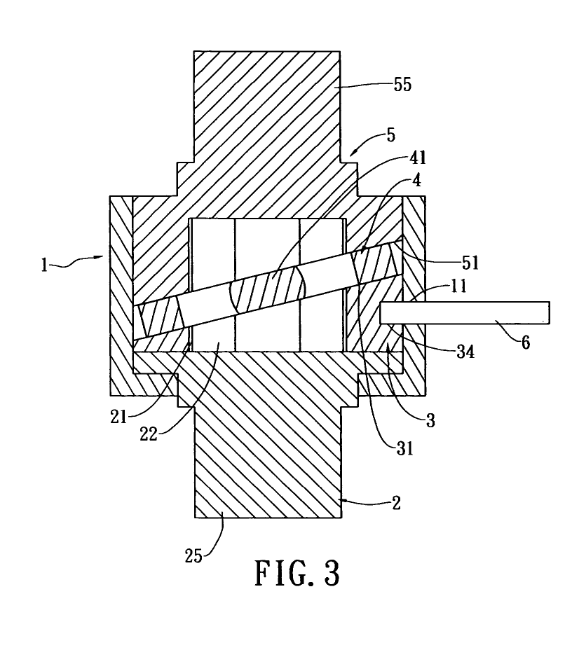

The driving element 3 is movably sleeved over the assemble shaft 21 of the lower mount 2, as shown in FIG. 2. The driving element 3 is an annular plate structure with two driving planes 31, 32 which are formed on one end thereof. In a rotational operation, either the driving plane 31 or the driving plane 32 will be engaged with the rotational disk 4 and the upper mount 5 as shown in FIG. 3. Whether the rotational operation utilizes the driving plane 31 or the driving plane 32 will depend upon the setting of the switch device 6. Further, the driving plane 31 and the driving plane 32 mirror each other; both driving planes descend at the same rate and are opposite each other. A slope transition area 33, which is the summit point of the driving element 3, is formed at the junction of the driving plane 31 and the driving plane 32. The slope transition area 33 is suitable for preventing reverse slippage. The driving element 3 further comprises an assemble hole 34 into which the switch device 6 is assembled through the slot opening 11 of the shell body 1 for selection of rotational direction.

The rotational disk 4 comprises an assemble block 41 and two semi cylindrical openings which correspond to the semi cylindrical plates 22, 23 of the lower mount 2. The semi cylindrical plates 22, 23 of the lower mount 2 are inserted into the semi cylindrical openings of the rotational disk 4. Thus, the rotational disk 4 is rotated simultaneously with the lower mount 2. One end surface of the rotational disk 4 is engaged with the upper mount 5 while the other end surface is engaged with either the driving plane 31 or the driving plane 32. Thereby, the present invention is capable of driving a rotation.

The upper mount 5, which is opposite the lower mount 2, is installed inside the shell body 1. The upper mount 5 includes a connecting head 55, which is able to connect to a product or a tool utilizing the present invention; and an oblique plane 51. The oblique plane 51 has a slope which is the inverse of the slope of the driving planes 31, 32. Because the slopes of the oblique plane 51 and the driving planes 31, 32 are inverse, the upper mount 5 is capable of engaging with either of the driving slopes surfaces 31, 32.

The switch device 6 is utilized to enable either the driving plane 31 or the driving plane 32 to engage with the rotational disk 4 for controlling and selecting the rotational direction. As illustrated in FIG. 1 through FIG. 3, the switch device 6 is a finger element with a rod shape. One end of the switch device 6 is assembled into the assemble hole 34 of the driving element 3. The opposite end of the switch device 6 protrudes outward through the slot opening 11 of the shell body 1 for facilitating the selection of the rotational direction.

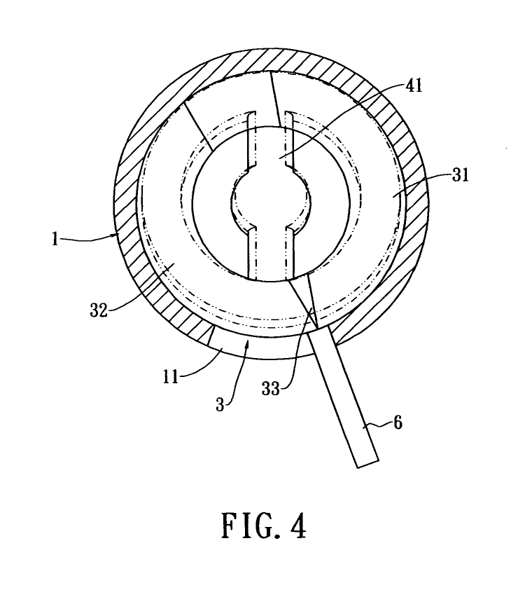

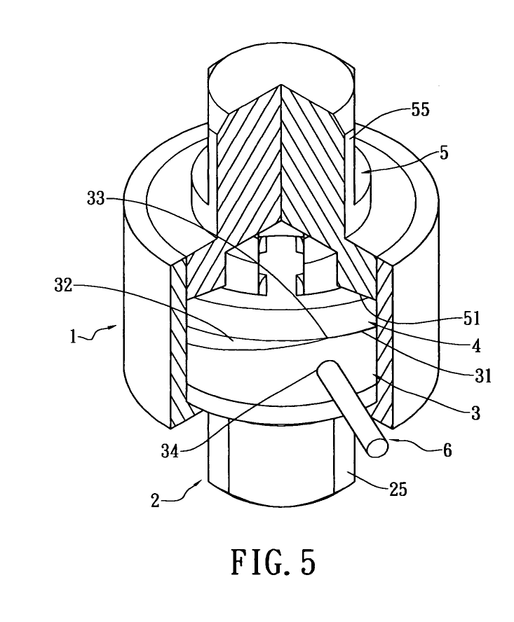

The operation of a stepless rotational joint in accordance with the present invention is illustrated in FIG. 3 through FIG. 9. When a consumer pushes the switch device 6 toward one side to set the stepless rotational joint under the first rotational direction, as shown in FIG. 4, the driving element 3 is rotated simultaneously. The driving plane 31, which drives the rotational disk 4 to rotate under the first rotational direction, is, therefore, engaged with the oblique plane 51 of the upper mount 5 through the rotational disk 4, as shown in FIG. 3 and FIG. 5. At the same time, the driving plane 32 is disengaged from the rotational disk 4 because a gap is formed between the driving plane 32 and the oblique plane 51. Accordingly, when the upper mount 5 applies a torque along the selected rotational direction, the rotational disk 4 will be driven to rotate along the selected direction because the top and the bottom end surfaces of the rotational disk 4 are respectively engaged with the oblique plane 51 of the upper mount 5 and the driving plane 31. The rotation of the rotational disk 4 will further drive the lower mount 2 to rotate synchronously along the selected direction.

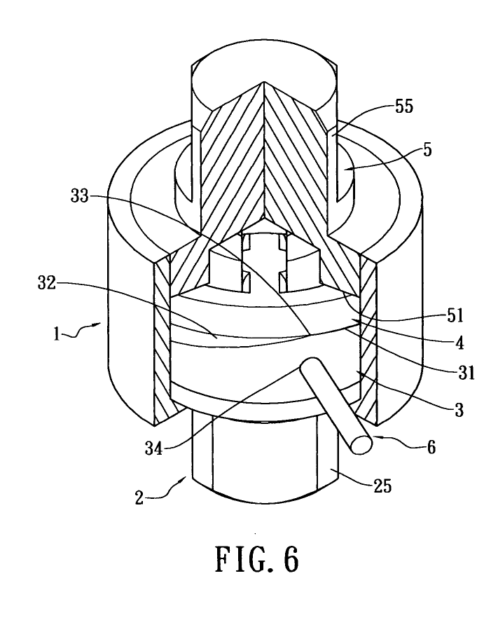

When the upper mount 5 applies a torque opposite to the selected rotational direction, the driving plane 31 is disengaged with the rotational disk 4 and the oblique plane 51 of the upper mount 5. The rotational disk 4 is further pushed downward and against the transition area 33 of the driving element 3. The upper mount 5 is thereby oriented because the transition area 33, the rotational disk 4, and the oblique plane 51 are interlocked together, as shown in FIG. 6.

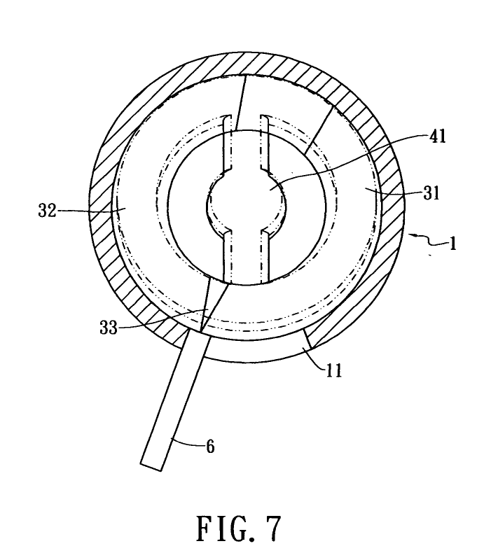

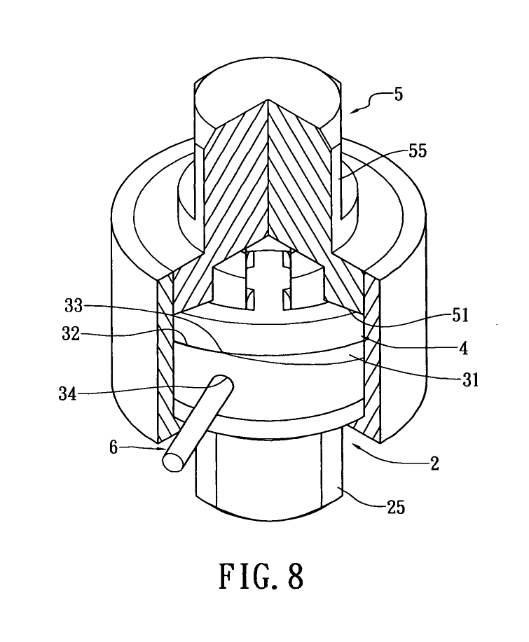

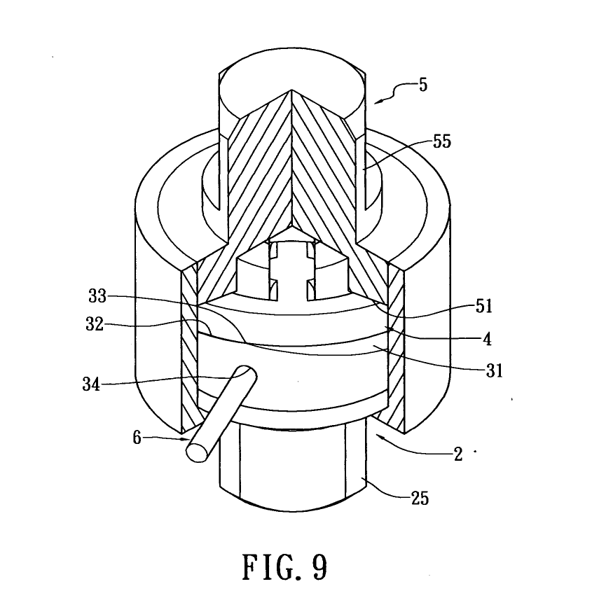

The consumer can also select the other rotational direction by pushing the switch device 6 toward the other side to set the stepless rotational joint under the second rotational direction, as shown in FIG. 7. The driving plane 32, which drives the rotational disk 4 to rotate under the second rotational direction, is, therefore, engaged with the oblique plane 51 of the upper mount 5 through the rotational disk 4, as shown in FIG. 8. Thereby, a similar operation and rotation can be attained in the second rotational direction. Further, the reverse slippage can be prevented by interlocking together the transition area 33, the rotational disk 4, and the oblique plane 51, as shown in FIG. 9.

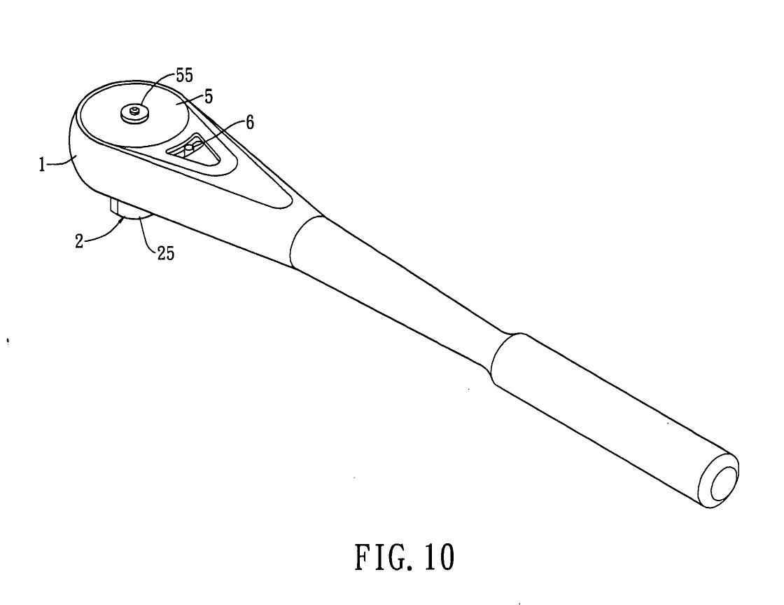

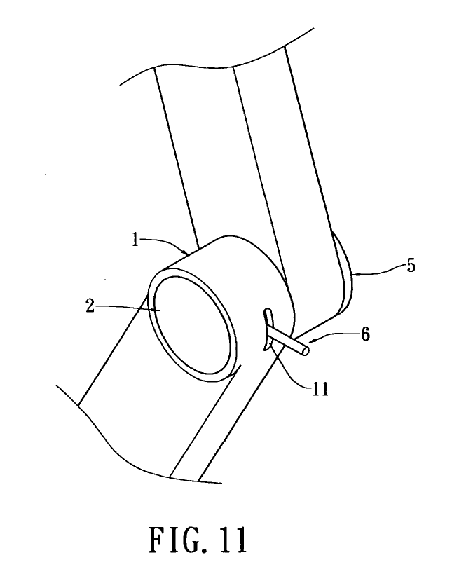

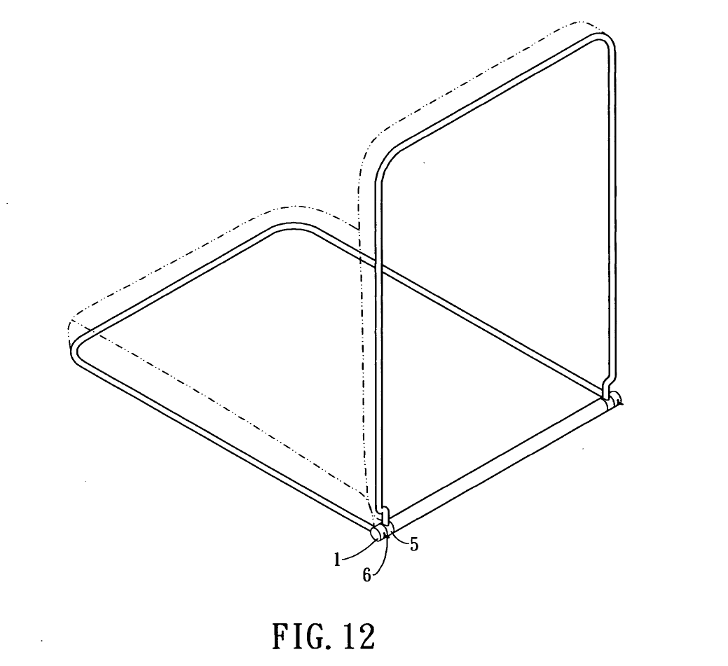

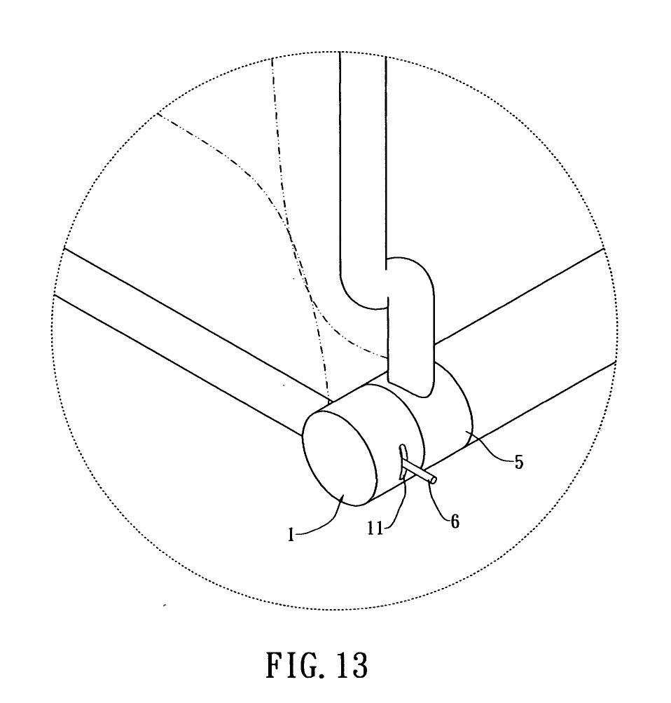

The present invention utilizes either of the driving planes 31, 32 to engage with the rotational disk 4 and the oblique plane 51 of the upper mount 5. The present invention is stepless so that it is more precise than conventional arts are. As shown in FIG. 10 through FIG. 13, the present invention can be actually utilized in a wrench, a lamp brace, or a chair. The stepless rotational joint of the present invention may be assembled or incorporated into aforementioned products through its connecting heads 25, 55 or through the structures of the lower mount 2 and the upper mount 5. Thus, the stepless rotational joint is able to utilize its driving element 3, the rotational disk 4, and the upper mount 5 to attain a bi-directional rotation.

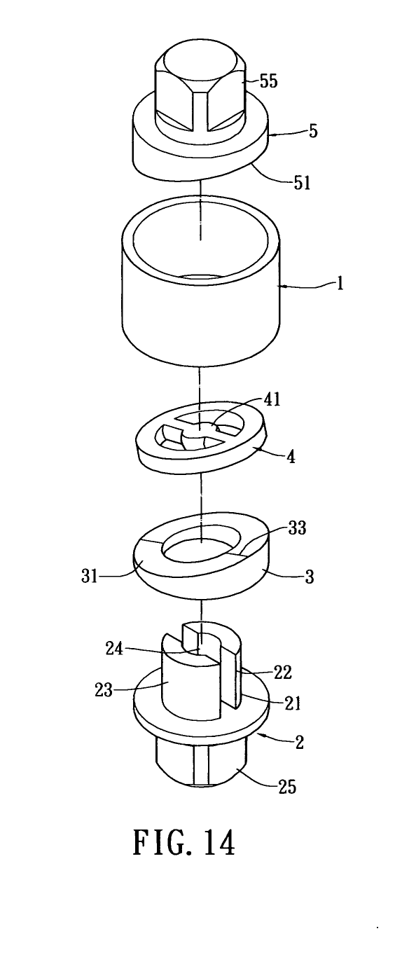

Referring to FIG. 14, an embodiment of the stepless rotational joint of the present invention capable of a single directional operation is shown. The stepless rotational joint of the present embodiment includes a shell body 1, a lower mount 2, a driving element 3, a rotational disk 4, and an upper mount 5. The shell body 1 is shaped into a hollow cylinder within which the lower mount 2, the driving element 3, the rotational disk 4, and the upper mount 5 are installed.

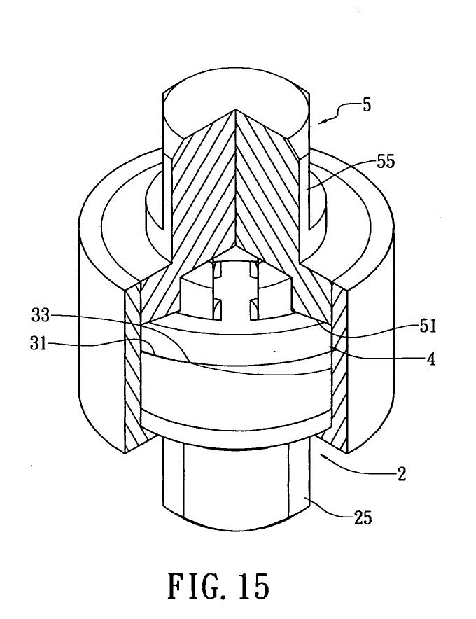

The driving element 3 of the present embodiment is different from that of the aforementioned embodiment. The driving element 3 of the present embodiment has only one driving plane 31 formed on one end thereof. The driving plane 31 is able to engage with the rotational disk 4 and the upper mount 5. This engagement enables the stepless rotational joint to perform a single direction operation, as shown in FIG. 15. Further, a slope transition area 33 is also formed between the driving plane 31 and one end surface of the driving element 3. The slope transition area 33 is able to orient the stepless rotational joint and prevent the stepless rotational joint from reverse slippage. In addition, the stepless rotational joint can be installed inversely to utilize the present embodiment in the other rotational direction.

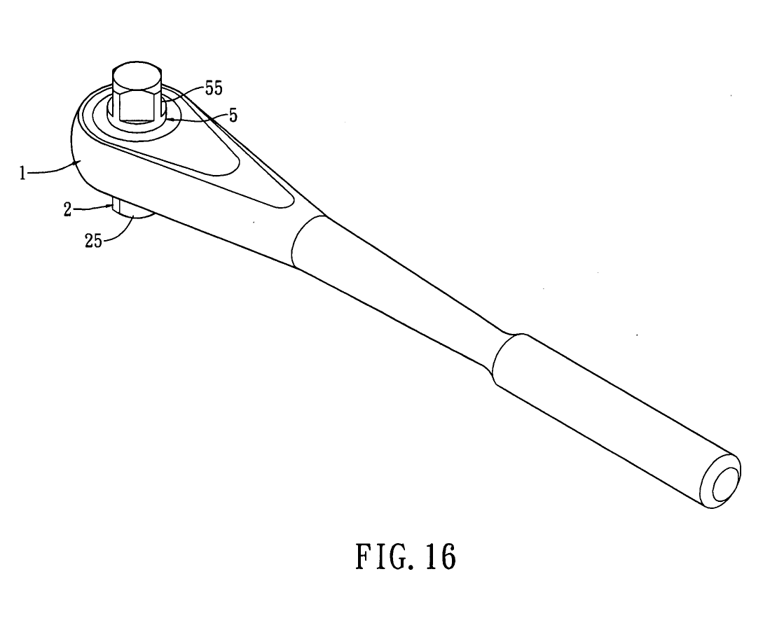

As shown in FIG. 16, the present embodiment can be actually utilized in a single directional wrench. The stepless rotational joint may be assembled or incorporated into aforementioned products through its connecting heads 25, 55 or through the structures of the lower mount 2 or the upper mount 5. Thus, the stepless rotational joint is able to utilize its driving element 3, the rotational disk 4, and the upper mount 5 to attain a single directional rotation.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A stepless rotational joint, comprising:
a shell body with a slot opening formed at one side thereof;
a lower mount with an assemble shaft, which is installed inside the shell body;
a driving element with two driving planes, which is sleeved over the lower mount;
a switch device assembled onto the driving element;
an upper mount with a oblique plane; and
a rotational disk installed between the driving element and the upper mount.

2. The stepless rotational joint of claim 1, wherein the lower mount further comprises a connecting head at one end thereof, and wherein the assemble shaft, extending from the other end of the lower mount toward the shell body, comprises two semi cylindrical plates separated by an assemble slot;

3. The stepless rotational joint of claim 2, wherein the connecting head of the lower mount is connected to a controlled end of a product utilizing the present invention.

4. The stepless rotational joint of claim 1, wherein the driving element further comprises a slope transition area formed between the two driving planes and a assemble hole bored at one side thereof, and wherein the two driving planes mirror each other with the same descending rate.

5. The stepless rotational joint of claim 1, wherein the rotational disk comprises an assemble block and two semi cylindrical openings corresponding to the semi cylindrical plates of the lower mount.

6. The stepless rotational joint of claim 1, wherein the upper mount further comprises a connecting head on one end thereof, and wherein the oblique plane of the upper mount has a slope which is the inverse of the slope of the driving planes of the driving element.

7. The stepless rotational joint of claim 1, wherein the switch device is a finger element with a rod shape, one end thereof assembled into an assemble hole of the driving element while the opposite end thereof protruding outward through the slot opening of the shell body.

8. A stepless rotational joint, comprising:
a shell body;
a lower mount with an assemble shaft, which is installed inside the shell body;
a driving element with a driving plane, which is sleeved over the lower mount;
an upper mount with an oblique plane; and
a rotational disk installed between the driving element and the upper mount.

9. The stepless rotational joint of claim 8, wherein the driving element further comprises a slope transition area formed between the driving plane and one end surface of the driving element.
